(19) United States
(12) Patent Application Publication
(10) Pub. No.: US 2020/0160393 A1
(43) Pub. Date: May 21, 2020

(54) INFORMATION PROCESSING APPARATUS, INFORMATION PROCESSING SYSTEM, AND ADVERTISEMENT DISTRIBUTION METHOD FOR VEHICLE

(71) Applicant: TOYOTA JIDOSHA KABUSHIKI KAISHA, Toyota-shi (JP)

(72) Inventors: Tsugumi OTSUKA, Nagoya-shi (JP); Kazuya NISHIMURA, Okazaki-shi (JP); Yuki ITO, Iwakura-shi (JP); Akio UOTANI, Nagoya-shi (JP); Makoto AKAHANE, Nagoya-shi (JP); Wataru SHIINA, Nagoya-shi (JP)

(73) Assignee: TOYOTA JIDOSHA KABUSHIKI KAISHA, Toyota-shi (JP)

(21) Appl. No.: 16/666,923

(22) Filed: Oct. 29, 2019

(30) Foreign Application Priority Data
Nov. 15, 2018 (JP) 2018-214533

(51) Int. Cl. G06Q 30/02; G01C 21/34; G01C 21/36

(52) U.S. Cl. CPC G06Q 30/0266; G06Q 30/0207; G01C 21/3667; G01C 21/3605; G01C 21/3438

(57) ABSTRACT

An information processing apparatus includes a processor configured to execute acquiring a destination of a crew of a first vehicle that is a vehicle including a display device installed toward an outside of the vehicle and that is to carry a first user who wants to move by a vehicle, acquiring advertisement information associated with the destination, generating a route to the destination of the first vehicle to pass through an area where presence of a user corresponding to a target of the advertisement information is expected, and transmitting, to the first vehicle, the advertisement information, a display instruction of the advertisement information to the display device, and route information of the generated route.

### CROSS REFERENCE TO RELATED APPLICATION

This application claims the benefit of Japanese Patent Application No. 2018-214533, filed on Nov. 15, 2018, which is hereby incorporated by reference herein in its entirety.

### BACKGROUND

### Technical Field

The present disclosure relates to an information processing apparatus, an information processing system, and an advertisement distribution method for a vehicle.

### Description of the Related Art

A technology is disclosed in which a display device is provided in a vehicle body of a bus, and an advertisement video corresponding to a current position of the bus is displayed in the display device when the bus travels (e.g., Patent Document 1).

### CITATION LIST

### Patent Document

Patent document 1: Japanese Patent Laid-Open No. 2003-241698

It is an object of the present disclosure to provide an information processing apparatus, an information processing system and an advertisement distribution method for a vehicle that are capable of improving an advertising effect to a user corresponding to an advertisement target.

### SUMMARY

One of aspects of the present disclosure is an information processing apparatus including a processor configured to execute acquiring a destination of a crew of a first vehicle that is a vehicle including a display device installed toward an outside of the vehicle and that is able to carry a first user who wants to move by a vehicle,

acquiring advertisement information associated with the destination,
generating a route of the first vehicle to the destination such that the first vehicle passes through an area where presence of a user corresponding to a target of the advertisement information is expected, and transmitting, to the first vehicle, the advertisement information, a display instruction of the advertisement information to the display device, and route information of the generated route.

One of the other aspects of the present disclosure is an information processing system including one or more processor configured to execute acquiring a destination of a crew of a first vehicle that is a vehicle including a display device installed toward an outside of the vehicle and that is able to carry a first user who wants to move by a vehicle,

acquiring advertisement information associated with the destination,
generating a route of the first vehicle to the destination such that the first vehicle passes through an area where presence of a user corresponding to a target of the advertisement information is expected, and transmitting, to the first vehicle, the advertisement information, a display instruction of the advertisement information to the display device, and route information of the generated route.

One of the other aspects of the present disclosure is an advertisement distribution method including acquiring a destination of a crew of a first vehicle that is a vehicle including a display device installed toward an outside of the vehicle and that is able to carry a first user who wants to move by a vehicle, acquiring advertisement information associated with the destination,

generating a route of the first vehicle to the destination such that the first vehicle passes through an area where presence of a user corresponding to a target of the advertisement information is expected, and transmitting, to the first vehicle, the advertisement information, a display instruction of the advertisement information to the display device, and route information of the generated route.

According to the present disclosure, it is possible to improve an advertising effect to a user corresponding to a target of advertisement.

### BRIEF DESCRIPTION OF DRAWINGS

FIG. 1 is a diagram illustrating an example of a system configuration of an advertisement-for-vehicle distribution system according to a first embodiment;

FIG. 2 is a diagram illustrating an example of a hardware configuration of each of the center server and the vehicle;

FIG. 3 is a diagram illustrating an example of an appearance of the vehicle including the display device installed toward the outside of the vehicle;

FIG. 4 is a diagram illustrating an example of a functional configuration of each of the center server and the in-vehicle device;

FIG. 5 is a diagram illustrating an example of a data structure of the share-ride user schedule information DB;

FIG. 6 is a diagram illustrating an example of a data structure of the driving user schedule information DB;

FIG. 7 is a diagram illustrating an example of a data structure of the reservation information DB;

FIG. 8 is an example of an advertisement information management table stored in the advertisement information DB;

FIG. 9 is an explanatory view of route generation of the center server;

FIG. 10 is a diagram illustrating an example of a data structure of the route information DB;

FIG. 11 is an example of a flowchart of advertisement distribution processing of the center server according to the first embodiment;

FIG. 12 is an example of a flowchart of ride reservation processing of the center server according to the first embodiment;

FIG. 13 is an example of a flowchart of ride confirmation processing of the center server according to the first embodiment;

FIG. 14 is an example of a flowchart of arrival confirmation processing of the center server according to the first embodiment;

FIG. 15 is a diagram illustrating an example of a sequence of the processing of the advertisement-for-vehicle distribution system when the vehicle starts traveling; and

FIG. 16 is a diagram illustrating an example of a sequence of processing in the advertisement-for-vehicle distribution system, when the share-ride user rides in the vehicle.

### DESCRIPTION OF THE EMBODIMENTS

One of aspects of the present disclosure is an information processing apparatus including a processor configured to execute acquiring a destination of a crew of a first vehicle that is a vehicle including a display device installed toward an outside of the vehicle and that is able to carry a first user who wants to move by a vehicle, acquiring advertisement information associated with the destination, generating a route of the first vehicle to the destination such that the first vehicle passes through an area where presence of a user corresponding to a target of the advertisement information is expected, and transmitting, to the first vehicle, the advertisement information, a display instruction of the advertisement information to the display device, and route information of the generated route.

The first vehicle is, for example, a private car, and a vehicle provided for a ridesharing service. The ridesharing service is a service of matching the vehicle (or a driver of the vehicle) scheduled to move to a predetermined destination with the user who has a destination in the same direction as in the predetermined destination so that the user rides in the vehicle for convenience, to share the movement by the vehicle. The area where the presence of the user corresponding to the target of the advertisement information is expected is set, for example, by an advertiser. However, the present disclosure is not limited to this example.

According to the one aspect of the present disclosure, the advertisement information associated with the destination of the first vehicle is displayed in the display device of the first vehicle. Furthermore, the information of the route to pass through the area where the presence of the user corresponding to the target of the advertisement information is expected is transmitted to the first vehicle. Consequently, for example, there is a high possibility that the first vehicle passes through the area where the presence of the user corresponding to the target of the advertisement information displayed in the display device of the first vehicle is expected. It is possible to urge the user of the target of the advertisement information to visit the destination of the first vehicle, and to improve an advertising effect. Furthermore, it is also possible to urge the first user who wants to move by the vehicle to ride together in the first vehicle to the same destination as that of the first vehicle.

Furthermore, according to one of the aspects of the present disclosure, when the first vehicle arrives at the destination, the processor may be configured to execute determining a discount rate or a discount amount of a coupon usable in a facility that is present in the destination in accordance with a number of the first users who ride together in the first vehicle, and transmitting the coupon to a user terminal owned by the crew of the first vehicle. For example, the discount rate or the discount amount of the coupon is set to be higher as the number of the first users who ride together in the first vehicle increases.

This can strengthen motivation for the first user to ride together in the first vehicle. Furthermore, it is possible to carry more users to the destination associated with the advertisement information, so that the advertising effect improves.

Additionally, according to one of the aspects of the present disclosure, when the first vehicle arrives at the destination, the processor may be configured to execute determining a discount rate or a discount amount of a coupon usable in a facility that is present in the destination in accordance with presence/absence of passage through the area where the presence of the user corresponding to the target of the advertisement information included in the route is expected, and transmitting the coupon to the user terminal owned by the crew of the first vehicle. This can further strengthen motivation for the driver of the first vehicle to travel along the route via the area where the presence of the user corresponding to the target of the advertisement information generated by the information processing apparatus is expected.

In the following, an embodiment of the present disclosure will be described with reference to the drawings. The configuration of the embodiment described below is an example, and the present disclosure is not limited to the configuration of the embodiment.

### First Embodiment

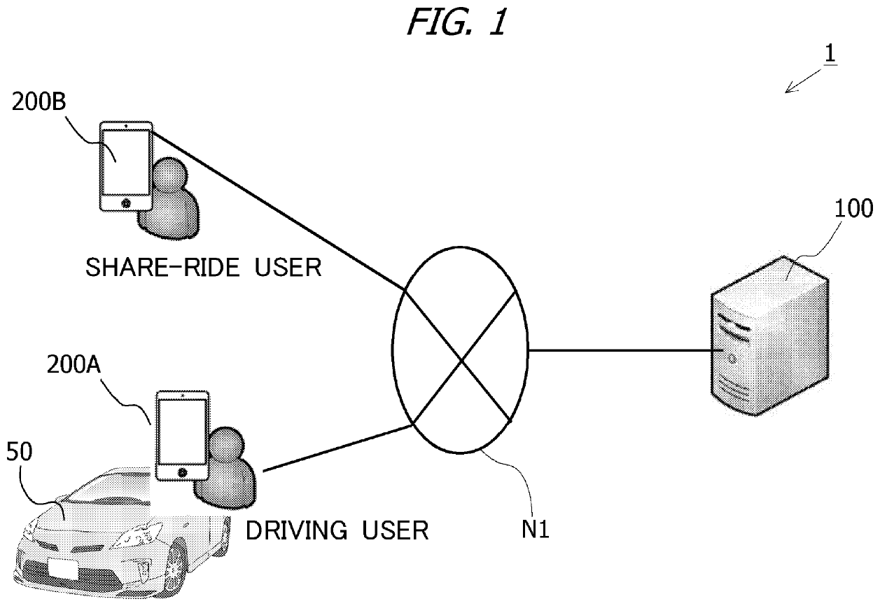

FIG. 1 is a diagram illustrating an example of a system configuration of an advertisement-for-vehicle distribution system 1 according to a first embodiment. The advertisement-for-vehicle distribution system 1 is a system that distributes and displays advertisement information associated with a destination of the vehicle to a display device provided in the vehicle and directed toward an outside of the vehicle which is used in a ridesharing service. The advertisement-for-vehicle distribution system 1 is an example of “an information processing system”.

The ridesharing service is a service of matching the vehicle (or the driver of the vehicle) scheduled to move to a predetermined destination with a user who has a destination in the same direction as in the predetermined destination so that the user rides in the vehicle for convenience, to share the movement by the vehicle. For example, a predetermined reward may be paid to the driver of the vehicle. Examples of the reward to be paid to the driver of the vehicle include a point usable for a predetermined service, and a discount coupon.

The advertisement-for-vehicle distribution system 1 includes a vehicle 50, a driving user terminal 200A held by a driving user who is a driver of the vehicle 50, a share-ride user terminal 200B held by a share-ride user who wants to ride in the vehicle 50 as a non-driving user, and a center server 100. The advertisement-for-vehicle distribution system 1 includes a plurality of vehicles 50, driving user terminals 200A, and share-ride user terminals 200B. However, FIG. 1 extracts and illustrates each one of them for simplicity. Furthermore, when the driving user terminal 200A is not distinguished from the share-ride user terminal 200B, a user terminal 200 is simply described. The share-ride user is an example of “a first user”.

Each user terminal 200 and the center server 100 are connected to a network N1, and are connected to each other via the network N1. In the network N1, for example, a wide area network (WAN) that is a worldwide public communication network such as internet or another communication network may be employed. Furthermore, the network N1 may include a mobile communication network such as a mobile phone and a radio communication network such as Wi-Fi.

Each of the driving user and the share-ride user is, for example, a user who installs an application of the ridesharing service provided by the advertisement-for-vehicle distribution system 1 in the user terminal 200, and registers the user as either the driving user or the share-ride user through the application. Examples of the user terminal 200 include mobile terminals, such as a smartphone, a tablet terminal, a notebook personal computer (PC) and a mobile phone terminal.

The driving user registers schedule information of a moving schedule by the vehicle 50 in the center server 100 through the driving user terminal 200A. The share-ride user transmits a ride reservation request to the center server 100 through the share-ride user terminal 200B. Schedule information indicating that the movement by the vehicle 50 is desired is also transmitted together with the ride reservation request. The schedule information includes, for example, a departure spot, a destination, a scheduled departure time or a desired departure time (in case of the share-ride user), and a scheduled arrival time or a desired arrival time (in case of the share-ride user).

Upon receiving the ride reservation request from the share-ride user terminal 200B, the center server 100 checks the schedule information of the share-ride user with the schedule information of the driving user registered in advance, and determines the driving user and/or the vehicle 50 to accept the share-ride user. The determining of the driving user and/or the vehicle 50 to accept the share-ride user or the determining of the share-ride user who rides in the vehicle 50 of the driving user based on the schedule information will be referred to as “matching”.

The center server 100 determines, based on the schedule information of the matched share-ride user and driving user, a scheduled meeting spot and a scheduled meeting time of both the users. The center server 100 transmits the ride reservation request to the driving user terminal 200A of the matched driving user, and makes confirmation with the matched driving user. Identification information of a ride reservation and contents of the ride reservation are also transmitted together with the ride reservation request to the driving user terminal 200A of the driving user. The contents of the ride reservation include, for example, information on the share-ride user, the scheduled meeting spot, the scheduled meeting time, the destination of the share-ride user and the scheduled arrival time at the destination. The information on the share-ride user includes, for example, a user name, gender, age and contact address (a phone number or an electronic mail address) of the share-ride user.

When the center server 100 receives an OK response to the ride reservation request from the driving user terminal 200A, the ride reservation is established. When the ride reservation is established, the center server 100 transmits a notification of the ride reservation establishment to the share-ride user terminal 200B of a source of the ride reservation request. The identification information of the ride reservation and the contents of the ride reservation are also transmitted together with the notification of the ride reservation establishment to the share-ride user terminal 200B. The contents of the ride reservation include, for example, information on the driving user, the scheduled meeting spot, the scheduled meeting time, the destination of the share-ride user and the scheduled arrival time at the destination. The information on the driving user includes, for example, a user name, gender, age and contact address (a phone number or an electronic mail address) of the driving user, and information on the vehicle 50. The information on the vehicle 50 may be, for example, an image of the vehicle 50 or may be information on an appearance of the vehicle 50, such as a vehicle type, color or vehicle identification number of the vehicle 50.

In the first embodiment, the vehicle 50 is, for example, a private car. The vehicle 50 includes the display device installed toward the outside of the vehicle, and can display the advertisement information or the like in the display device. The center server 100 holds a database that stores the advertisement information associated with a predetermined facility. The vehicle 50 is an example of “a first vehicle”.

The center server 100 acquires, for example, the advertisement information of the facility that is present in the destination of the driving user of the vehicle 50, and displays the information in the display device installed in the vehicle 50 and directed toward the outside of the vehicle. Examples of the facility include a shop, a shopping center including a plurality of shops, a museum of art, a museum, and a sports facility. The advertisement information of the facility where the vehicle 50 is heading, which is displayed toward the outside of the vehicle 50, is seen by pedestrians, and can arouse pedestrians' interests in the facility. For example, when a number of the vehicles 50 each of which displays the advertisement information of the facility toward the outside of the vehicle increases, opportunities to see the advertisement information by the pedestrians can increase, and can motivate the pedestrian who sees the advertisement information to think about going to the facility. Such motivation improves.

Furthermore, the vehicle 50 is a vehicle provided to the ridesharing service. Therefore, when the advertisement information associated with the destination of the vehicle 50 is displayed, the share-ride user who wants to move to the same destination as the destination of the vehicle 50 can be motivated to use the ridesharing service.

Additionally, in the first embodiment, the center server 100 generates a route to pass through an area where presence of the user corresponding to a target of the advertisement information displayed in the vehicle 50 is expected, and transmits information of the generated route to the vehicle 50. For example, when the advertisement information is advertisement information of a supermarket, the target of the advertisement information is a housewife class, and the area where the presence of the user corresponding to the target of the advertisement information is expected is a residential district where more housewives are expected to be present. For example, when the advertisement information is advertisement information of an event for elementary school students, the target of the advertisement information is an elementary school student. The area where the presence of the user corresponding to the target of the advertisement information is expected is a vicinity of an elementary school where more elementary school students are expected to be present. The area where the presence of the user corresponding to the target of the advertisement information is expected may be determined, for example, by designation from an advertiser.

When the vehicle 50 that displays the advertisement information toward the outside of the vehicle travels along the route generated by the center server 100, the vehicle 50 passes through the area where the presence of the user corresponding to the target of the advertisement information is expected, and the advertisement information can further appeal to the user corresponding to the target.

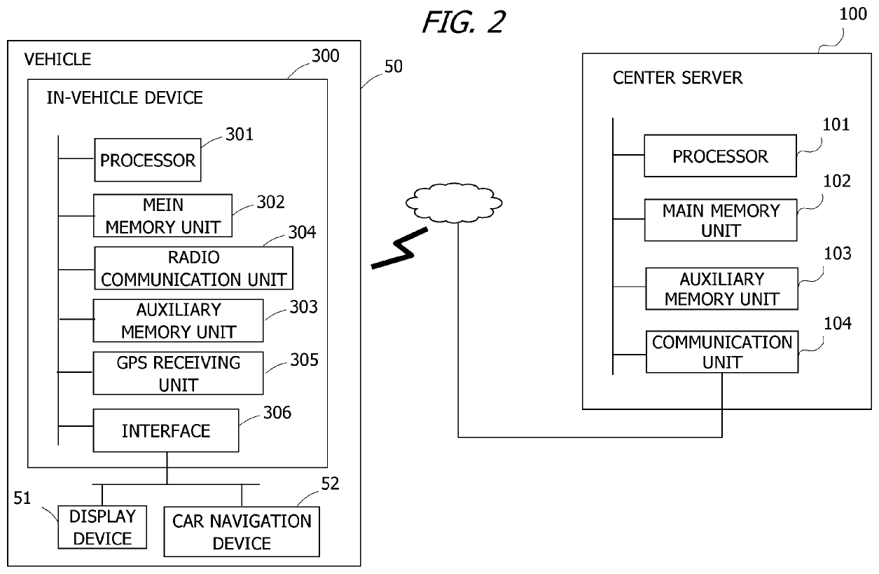

FIG. 2 is a diagram illustrating an example of a hardware configuration of each of the center server 100 and the vehicle 50. The center server 100 is, for example, a dedicated computer or a general purpose computer. The center server 100 has, as the hardware configuration, a processor 101, a main memory unit 102, an auxiliary memory unit 103, and a communication unit 104. These components are connected to one another by a bus. The main memory unit 102 and the auxiliary memory unit 103 are computer readable recording mediums. The center server 100 is an example of “an information processing apparatus”.

The auxiliary memory unit 103 stores various programs and data for use by the processor 101 during execution of each program. The auxiliary memory unit 103 is, for example, an erasable programmable ROM (EPROM) or a hard disk drive. The program held in the auxiliary memory unit 103 holds, for example, an operating system (OS), a vehicle advertisement distribution control program, and various other application programs. The vehicle advertisement distribution control program is a program to distribute the advertisement information associated with the destination to the vehicle 50 provided for the ridesharing service.

The main memory unit 102 is a memory unit that provides, in the processor 101, a memory area and a work area onto which the program stored in the auxiliary memory unit 103 is loaded, or that is for use as a buffer. Examples of the main memory unit 102 include semiconductor memories such as a read only memory (ROM) and a random access memory (RAM).

The processor 101 is, for example, a central processing unit (CPU). The processor 101 loads and executes OS and various application programs held in the auxiliary memory unit 103, on the main memory unit 102, thereby executing various processing. A number of the processors 101 is not limited to one, and a plurality of processors may be provided. The processor 101 is an example of “a processor”.

The communication unit 104 is an interface that inputs and outputs information to and from the network. The communication unit 104 may be an interface that connects to a wired network or an interface that connects to a radio network. The communication unit 104 is, for example, a network interface card (NIC) or a radio circuit.

The vehicle 50 includes an in-vehicle device 300, a display device 51, and a car navigation device 52. Note that FIG. 2 extracts and illustrates hardware components associated with the first embodiment, and the other hardware components included in the vehicle 50 are omitted.

The in-vehicle device 300 is, for example, a data communication device mounted in the vehicle 50, or a control device of a predetermined system. Examples of the predetermined system include an automatic driving system, an advanced driving support system, and a car navigation system. Note that the in-vehicle device 300 is not limited to these examples. Hereinafter, in the first embodiment, the in-vehicle device 300, which is assumed to be the data communication device, will be described.

The in-vehicle device 300 includes, as the hardware components, for example, a processor 301, a main memory unit 302, an auxiliary memory unit 303, a radio communication unit 304, a global positioning system (GPS) receiving unit 305, and an interface 306. The processor 301, the main memory unit 302 and the auxiliary memory unit 303 are similar to the processor 101, the main memory unit 102, and the auxiliary memory unit 103. However, for example, a control program for the in-vehicle device of the advertisement-for-vehicle distribution system 1 is stored in the auxiliary memory unit 303 of the in-vehicle device 300. The control program for the in-vehicle device of the advertisement-for-vehicle distribution system 1 is, for example, a program to acquire the advertisement information from the center server 100 and display the information in the display device 51.

The radio communication unit 304 is, for example, a mobile communication unit of LTE, LTE-advanced, 3G or the like, or a radio communication circuit of Wi-Fi, DSRC or the like. The radio communication unit 304 connects to an access network in accordance with a corresponding radio communication system via radio communication, connects to a public circuit network through the access network, or connects to the center server 100 or the like through the public circuit network.

The GPS receiving unit 305 receives radio waves of time signals from a plurality of artificial satellites orbiting around the earth, and stores the time signals in a register provided in the processor 301. The processor 301 calculates, for example, a latitude and a longitude indicating a position on the earth from a detection signal of the GPS receiving unit 305, and acquires positional information of the vehicle 50 (the in-vehicle device 300).

The interface 306 is, for example, an interface to connect to the display device 51 and the car navigation device 52. The interface 306 may connect to the display device 51 and the car navigation device 52 directly with a cable or the like, or may connect to an in-vehicle network (CAN: controller area network), and connect to the display device 51 and the car navigation device 52 through the CAN.

Note that the hardware configuration of each of the center server 100 and the in-vehicle device 300 illustrated in FIG. 2 is an example. The present embodiment is not limited to the above example, and components can be suitably omitted, replaced or added in accordance with the embodiment. For example, the center server 100 may include a removable recording medium driving device, to execute a program recorded in the removable recording medium. Examples of the removable recording medium include recording mediums such as an SD card, a mini SD card, a micro SD card, a universal serial bus (USB) flash memory, a compact disc (CD), a digital versatile disc (DVD), a Blue-ray (registered trademark) disc, and a flash memory card. Alternatively, for example, the center server 100 may include an input device and an output device. Examples of the input device include a keyboard, a mouse, and a touch panel. The output device is, for example, a display.

Note that a series of processing executed by the center server 100 and the in-vehicle device 300 is not limited to execution of software achieved by the processors 101 and 301. For example, the processing may be achieved by hardware such as a field-programmable gate array (FPGA).

Note that drawing of a hardware configuration of the user terminal 200 is omitted. The user terminal 200 has, for example, a display unit and an input unit in addition to the above described processor, main memory unit, auxiliary memory unit and communication unit. Examples of the display unit include a liquid crystal display (LCD) and an electroluminescence (EL) panel. Examples of the input unit include a touch panel and a pressing button. Alternatively, the input unit can include a camera that can input a video or an image, and a microphone that can input a voice. The communication unit is, for example, a communication circuit to access the network N1 by use of a mobile communication network such as the mobile phone, or, radio communication such as Wi-Fi or the like. The user terminal 200 transmits, for example, the ride reservation request, the schedule information, and user information to the center server 100 by an input operation into the application through the input unit from the user.

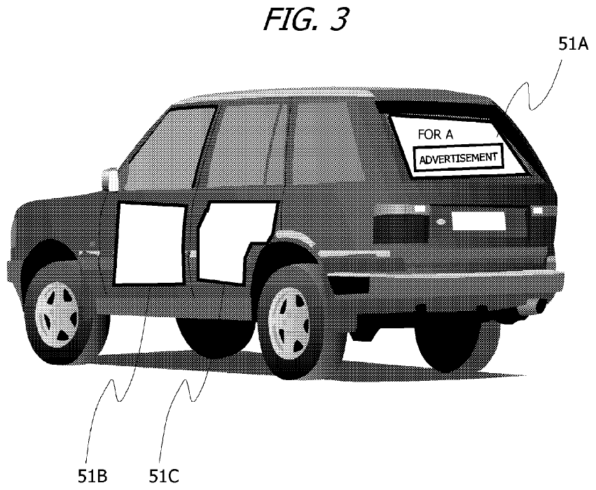

FIG. 3 is a diagram illustrating an example of an appearance of the vehicle 50 including the display device 51 installed toward the outside of the vehicle. For example, one or more display devices 51 installed toward the outside of the vehicle are provided in the vehicle 50. Examples of the display device 51 installed toward the outside of the vehicle 50 include a liquid crystal display, an organic EL display, an LED matrix, and a projector. Alternatively, the display device 51 installed toward the outside of the vehicle 50 may be window glass (e.g., a side window or a rear window), for example, when the video can be projected on the glass.

FIG. 3 illustrates the appearance of the vehicle 50 seen from a left rear, and illustrates a display device 51A at the rear of the vehicle, a display device 51B installed in a front door on a left side, and a display device 51C installed in a rear door on the left side. The display device 51A at the rear of the vehicle may be the rear window or a display installed in a rear inner part of the vehicle.

A number of display devices may vary, for example, in accordance with the type of vehicle 50 or a car type. The display devices may be arranged at a plurality of positions, such as the left side, a right side, the vehicle rear, and a vehicle upper part. For example, when a target vehicle is a truck, the display devices can be arranged at three positions on the left side, the right side, and the vehicle rear. Alternatively, when the target vehicle is a sedan, the display devices can be arranged on the left side (a front door), the left side (the rear door), the right side (the front door), and the right side (the rear door) and the like.

The advertisement information received from the center server 100 is displayed in the display device 51. Alternatively, for example, the destination may be displayed together with the advertisement information associated with the destination in the display device 51. For example, the destination may be displayed in a message such as “for XX” or “heading for XX”.

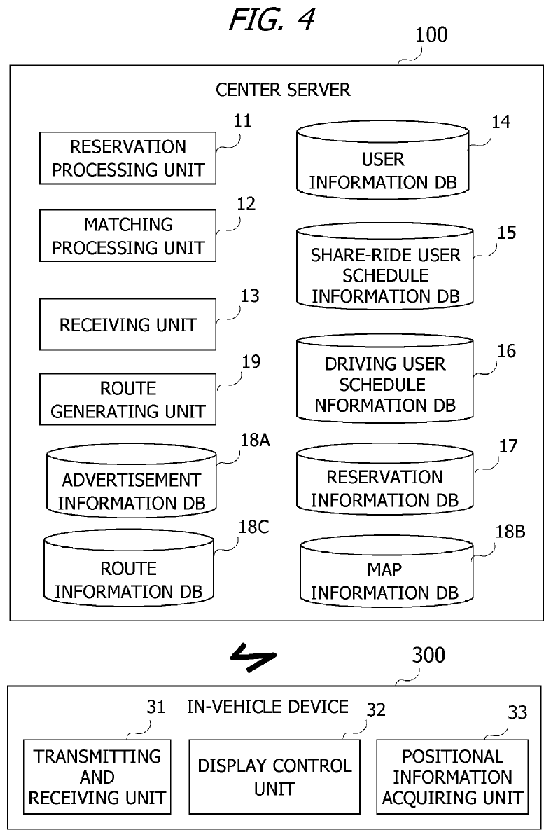

FIG. 4 is a diagram illustrating an example of a functional configuration of each of the center server 100 and the in-vehicle device 300. The in-vehicle device 300 includes a transmitting and receiving unit 31, a display control unit 32, and a positional information acquiring unit 33 as functional components. These functional components may be achieved, for example, by the processor 301 of the in-vehicle device 300 that executes the control program for the in-vehicle device of the advertisement-for-vehicle distribution system 1 which is stored in the auxiliary memory unit 303.

The transmitting and receiving unit 31 is an interface with the center server 100. The transmitting and receiving unit 31 transmits and receives data to and from the center server 100 through the radio communication unit 304. An example of the data to be transmitted to the center server 100 by the transmitting and receiving unit 31 is a travel start notification. An example of the data to be received from the center server 100 by the transmitting and receiving unit 31 is the advertisement information. The transmitting and receiving unit 31 outputs the advertisement information received from the center server 100 to the display control unit 32.

The display control unit 32 performs processing concerned with the display of the advertisement information. The display control unit 32 generates the travel start notification, and transmits the notification to the center server 100 through the transmitting and receiving unit 31, when a predetermined event occurs. Examples of the predetermined event may include start of navigation by the car navigation device 52, detection of start of an accelerator of the vehicle 50, change of a predetermined distance or more in the positional information acquired by the positional information acquiring unit 33 which will be described later, and an operation input of travel start from the driving user.

The display control unit 32 also transmits destination information together with the travel start notification to the center server 100. The destination information is, for example, a destination set to the car navigation device 52, and is acquired by inquiring the car navigation device 52. However, the present embodiment is not limited to this example, and the destination information may be input into the in-vehicle device 300 by an operation of the driving user. Examples of the destination information may include an address of the destination, a landmark name, and the latitude and longitude.

For example, after the display control unit 32 transmits the travel start notification to the center server 100, the display control unit 32 acquires the positional information from the after-mentioned positional information acquiring unit 33 in a predetermined period, to transmit the positional information to the center server 100. For example, the transmission of the positional information to the center server 100 is continued until the arrival at the destination is detected. However, the present embodiment is not limited to this example. The positional information may be transmitted to the center server 100 during an operation of the in-vehicle device 300.

The display control unit 32 receives, from the transmitting and receiving unit 31, inputs of the advertisement information, a display instruction of the advertisement information and route information received from the center server 100. The display control unit 32 outputs the input advertisement information to the display device 51, to display the information in the display device 51. The display control unit 32 outputs the input route information to the car navigation device 52, to execute the navigation of the route information. At this time, the display control unit 32 may also output the destination information together with the advertisement information to the display device 51, to display the destination information.

For example, on detecting the arrival at the destination, the display control unit 32 instructs the display device 51 to stop the display of the advertisement information. The arrival at the destination is detected, for example, by either detecting end of the navigation by the car navigation device 52 or detecting that the after-mentioned positional information indicates the destination. However, the present embodiment is not limited to this example.

The positional information acquiring unit 33 acquires, for example, the positional information of the vehicle 50 (the in-vehicle device 300) acquired by the GPS receiving unit 305 of the in-vehicle device 300 in a predetermined period. Examples of the positional information of the vehicle 50 include a latitude and a longitude. Furthermore, the positional information of the vehicle 50 may be, for example, an address. The period in which the positional information acquiring unit 33 acquires the positional information may be set to a range of, for example, from 0.1 to 10 seconds. However, the present embodiment is not limited to this example.

Next, the center server 100 includes, as functional components, a reservation processing unit 11, a matching processing unit 12, a transmitting and receiving unit 13, a user information database (DB) 14, a share-ride user schedule information DB 15, a driving user schedule information DB 16, a reservation information DB 17, an advertisement information DB 18A, a map information DB 18B, a route information DB 18C, and a route generating unit 19. These functional components are achieved by executing the vehicle advertisement distribution control program stored in the auxiliary memory unit 103 by the processor 101 of the center server 100.

The transmitting and receiving unit 13 is an interface with the user terminal 200 and the in-vehicle device 300. The transmitting and receiving unit 13 transmits and receives the data to and from the user terminal 200 and the in-vehicle device 300 through the communication unit 104. An example of the data received from the user terminal 200 by the transmitting and receiving unit 13 is the ride reservation request. The transmitting and receiving unit 13 outputs the data received from the user terminal 200 to the reservation processing unit 11.

The reservation processing unit 11 executes control regarding the ride reservation. The reservation processing unit 11 performs processing, for example, as follows. The reservation processing unit 11 stores the received user information in the after-mentioned user information DB 14, when receiving the user information from the user terminal 200 through the transmitting and receiving unit 13. When receiving the schedule information from the driving user terminal 200A through the transmitting and receiving unit 13, the reservation processing unit 11 stores the schedule information in the after-mentioned driving user schedule information DB 16.

Furthermore, the reservation processing unit 11 receives the positional information from the in-vehicle device 300 and the user terminal 200 through the transmitting and receiving unit 13 in a predetermined period. For example, the in-vehicle device 300 may transmit the positional information to the center server 100 during the travel of the vehicle 50, and the user terminal 200 may transmit the positional information to the center server from when the ride reservation is established until the ride is completed.

The reservation processing unit 11 receives the travel start notification indicating the travel start from the in-vehicle device 300 through the transmitting and receiving unit 13. The destination information is also received together with the travel start notification. The reservation processing unit 11 acquires, from the advertisement information DB 18A, the advertisement information associated with the facility that is present at a position indicated by the destination information.

Next, the reservation processing unit 11 outputs, to the route generating unit 19, a display desired area set to the advertisement information acquired in the after-mentioned advertisement information DB 18A, and the positional information of the vehicle 50, thereby requesting generation of a route to pass through the display desired area. The display desired area is an area where the advertiser desires that the vehicle 50 travels displaying the advertisement information in the display device 51 directed toward the outside of the vehicle, and an area where the presence of the user corresponding to the target of the advertisement information is expected. The display desired area is, for example, designated in advance by the advertiser of the advertisement information. The display desired area may be designated, for example, by area features such as a residential district and a shopping district, or by a specific town name or a section (a street number, a block number or the like). The display desired area is an example of “the area where the presence of the user corresponding to the target of the advertisement information is expected”.

When the route information is input from the route generating unit 19, the reservation processing unit 11 outputs the advertisement information, the display instruction of the advertisement information and the route information to the transmitting and receiving unit 13, and transmits the information to the in-vehicle device 300 through the transmitting and receiving unit 13.

On receiving the ride reservation request from the share-ride user terminal 200B through the transmitting and receiving unit 13, the reservation processing unit 11 requests the matching processing unit 12 to perform matching. Furthermore, the schedule information of the share-ride user is also received together with the ride reservation request from the share-ride user terminal 200B. The schedule information of the share-ride user is stored in the share-ride user schedule information DB 15 by the reservation processing unit 11.

The reservation processing unit 11 receives, for example, inputs of information of the driving user matched for the share-ride user of the user terminal 200B, the scheduled meeting spot and the scheduled meeting time from the matching processing unit 12. The reservation processing unit 11 transmits the ride reservation request to the user terminal 200A of the matched driving user through the transmitting and receiving unit 13. The identification information of the ride reservation and the contents of the ride reservation are also transmitted together with the ride reservation request.

The reservation processing unit 11 determines, when receiving the OK response to the ride reservation request from the user terminal 200A of the driving user through the transmitting and receiving unit 13, the establishment of the ride reservation and registers ride reservation information in the reservation information DB 17. The reservation processing unit 11 also transmits the notification of the ride reservation establishment to the user terminal 200B of the source of the ride reservation request through the transmitting and receiving unit 13. For example, the identification information of the ride reservation and the contents of the ride reservation are also transmitted together with the notification of the ride reservation establishment to the user terminal 200B of the source of the ride reservation request.

The reservation processing unit 11 monitors a status of the ride reservation. Examples of the status of the ride reservation include “prior to ride” indicating a state before the share-ride user rides in the vehicle 50, “during ride” indicating that the share-ride user is in the vehicle 50, and “completion” indicating that the vehicle arrives at the destination of the share-ride user and that the service for the ride reservation is completed.

Specifically, the reservation processing unit 11 monitors, for the ride reservation, whether the share-ride user completes riding in the vehicle 50 and arrives at the destination. For example, when the share-ride user of the ride reservation completes riding in the vehicle 50, a ride completion notification is transmitted to the center server 100 by respective user operations from the share-ride user terminal 200B and/or the driving user terminal 200A. For example, when the vehicle 50 arrives at the destination of the ride reservation, an arrival notification is transmitted to the center server 100 by the respective user operations from the share-ride user terminal 200B and/or the driving user terminal 200A. The reservation processing unit 11 monitors the status of the ride reservation in response to the receiving of the notification from the user terminal 200.

The reservation processing unit 11 receives an input of the arrival notification received from the share-ride user terminal 200B and/or the driving user terminal 200A through the transmitting and receiving unit 13. In this case, the reservation processing unit 11 generates coupon information corresponding to the advertisement information displayed in the display device 51 directed toward the outside of the vehicle 50. For example, the coupon information is generated based on setting of the coupon information stored in the after-mentioned advertisement information DB 18A. When the setting of the coupon information is “discount”, the reservation processing unit 11 determines a discount rate or a discount amount in accordance with the number of the share-ride users on arrival of the vehicle 50 at the destination, that is, the number of the share-ride users carried to the facility that is present in the destination by the vehicle 50. For example, the discount rate or the discount amount is set to be higher as the number of the share-ride users on arrival of the vehicle 50 at the destination increases.

Furthermore, for example, the reservation processing unit 11 records an actual travel route of the vehicle 50, and compares the actual travel route with the route information of the vehicle 50 generated by the route generating unit 19 and stored in the after-mentioned route information DB 18C, when the vehicle 50 arrives at the destination. When the vehicle 50 travels via the display desired area, the reservation processing unit 11 may issue a coupon as an incentive regardless of the number of the share-ride users who ride in the vehicle 50, or may add a predetermined value to the discount rate or the discount amount determined in accordance with the number of the share-ride users who ride in the vehicle 50.

The reservation processing unit 11 transmits the generated coupon information to the driving user terminal 200A and/or the share-ride user terminal 200B.

In response to the request from the reservation processing unit 11, the matching processing unit 12 matches the share-ride user corresponding to the share-ride user terminal 200B of the source of the ride reservation request with the driving user. A matching method of the matching processing unit 12 may be any well-known technology, and is not limited to a specific method. For example, the matching processing unit 12 extracts, from the after-mentioned driving user schedule information DB 16, the schedule information of the driving user including a period from a desired departure time to a scheduled arrival time of the schedule information of the share-ride user received together with the ride reservation request and including the destination or a passing spot, and the departure spot and the destination of the share-ride user, the destination being in a vicinity of the destination or the passing spot. The matching processing unit 12 selects a matching target of the share-ride user from the driving users of the extracted schedule information, for example, randomly or based on an evaluation value, an attribute or the like.

Furthermore, for example, the matching processing unit 12 determines the scheduled meeting spot based on the departure spot and destination of the share-ride user and the destination and passing spot of the driving user. Additionally, the matching processing unit 12 determines the scheduled meeting time based on the desired departure time and desired arrival time of the share-ride user and another ride reservation of the driving user. A method of determining the scheduled meeting spot and the scheduled meeting time may be any well-known technology, and is not limited to a specific method. The matching processing unit 12 outputs the information of the selected driving user, the scheduled meeting spot, the scheduled meeting time and others to the reservation processing unit 11.

The route generating unit 19 generates the route based on the request from the reservation processing unit 11. The positional information of the vehicle 50, destination information and information of the display desired area set to the advertisement information scheduled to be displayed in the display device 51 of the vehicle 50 are input from the reservation processing unit 11. The route generating unit 19 generates a route from a current position of the vehicle 50 via the display desired area to the destination, with reference to the map information DB 18B. Details of the route generated by the route generating unit 19 will be described later. The route generating unit 19 outputs the generated route information to the reservation processing unit 11.

Note that the processing of each of the reservation processing unit 11, the matching processing unit 12, the transmitting and receiving unit 13 and the route generating unit 19 may be executed by each of separate computers.

Each of the user information DB 14, the share-ride user schedule information DB 15, the driving user schedule information DB 16, the reservation information DB 17, the advertisement information DB 18A, the map information DB 18B and the route information DB 18C is constructed, for example, by managing the data stored in the auxiliary memory unit 103 by a program of a database management system (DBMS) executed by the processor 101. The user information DB 14, the share-ride user schedule information DB 15, the driving user schedule information DB 16, the reservation information DB 17, the advertisement information DB 18A, the map information DB 18B and the route information DB 18C are, for example, relational databases.

The user information DB 14 stores information on the user. The information on the user stored in the user information DB 14 includes, for example, user ID, user type, user attribute information, and information of the contact address of the user terminal 200, and vehicle ID, appearance information of the vehicle, a vehicle capacity and the like in a case where the user is the driving user.

The map information DB 18B stores map information. For example, the map information includes correspondence between positional information of the facility associated with the advertisement information and identification information of the facility.

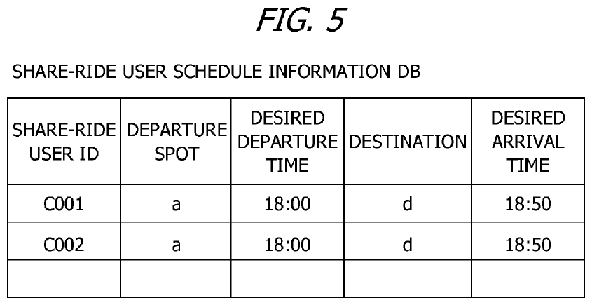

FIG. 5 is a diagram illustrating an example of a data structure of the share-ride user schedule information DB 15. The share-ride user schedule information DB 15 is a database that stores the schedule information of the share-ride user. The share-ride user schedule information DB 15 illustrated in FIG. 5 has fields of the user ID, the departure spot, the desired departure time, the destination and the desired arrival time.

In the field of the user ID, user identification information of the share-ride user is input. In each of the fields of the departure spot and the destination, for example, either one of the address, latitude and longitude of the departure spot or the destination is input. In each of the fields of the desired departure time and the desired arrival time, a date and time are input.

The information stored in the share-ride user schedule information DB 15 is registered, updated and deleted by the reservation processing unit 11. For example, when the schedule information is received together with the ride reservation request from the share-ride user terminal 200B, the schedule information is registered as a new entry of the share-ride user schedule information DB 15 by the reservation processing unit 11. For example, when the arrival notification is received from the share-ride user terminal 200B and it is indicated that the corresponding ride reservation ends, the corresponding entry may be deleted from the share-ride user schedule information DB 15. Note that the information to be stored in the share-ride user schedule information DB 15 is not limited to examples illustrated in FIG. 5, and each field can be suitably added, changed and deleted.

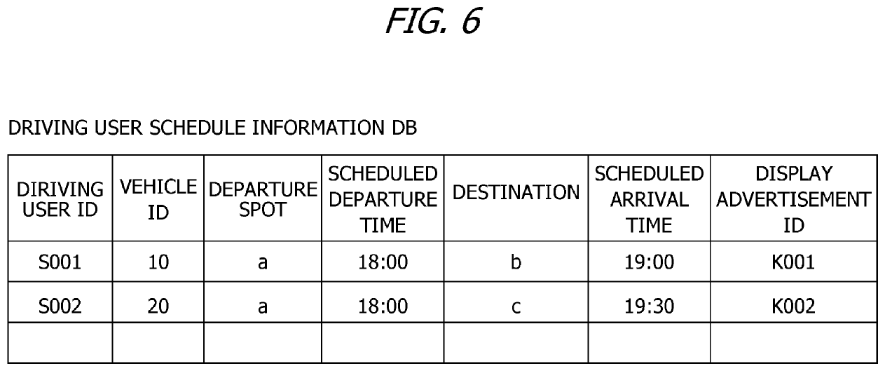

FIG. 6 is a diagram illustrating an example of a data structure of the driving user schedule information DB 16. The driving user schedule information DB 16 is a database that stores the schedule information of the driving user. The driving user schedule information DB 16 illustrated in FIG. 6 has fields of the user ID, departure spot, vehicle ID, scheduled departure time, destination, scheduled arrival time and display advertisement ID.

In the field of the user ID, user identification information of the driving user is input. In the field of the vehicle ID, identification information of the vehicle 50 is input. In each of the fields of the departure spot and the destination, one of the address, latitude and longitude of the departure spot or the destination is input. In each of the fields of the scheduled departure time and the scheduled arrival time, a date and time are input. Note that the information on the vehicle 50 is stored, for example, in the user information DB 14. Examples of the information on the vehicle 50 include the identification information of the vehicle, the identification information of the driving user, and car type, color and capacity.

In the field of the display advertisement ID, identification information of the advertisement information displayed or scheduled to be displayed in the display device 51 of the vehicle 50 is input. The field of the display advertisement ID is empty in an initial state.

The information stored in the driving user schedule information DB 16 is registered, updated and deleted by the reservation processing unit 11. For example, when the schedule information is received from the driving user terminal 200A, the schedule information is registered as a new entry of the driving user schedule information DB 16 by the reservation processing unit 11. Furthermore, when a predetermined time elapses from the scheduled arrival time of the schedule information, the entry may be deleted from the driving user schedule information DB 16. Note that the information stored in the driving user schedule information DB 16 is not limited to the examples illustrated in FIG. 6, and the field can be suitably added, changed and deleted.

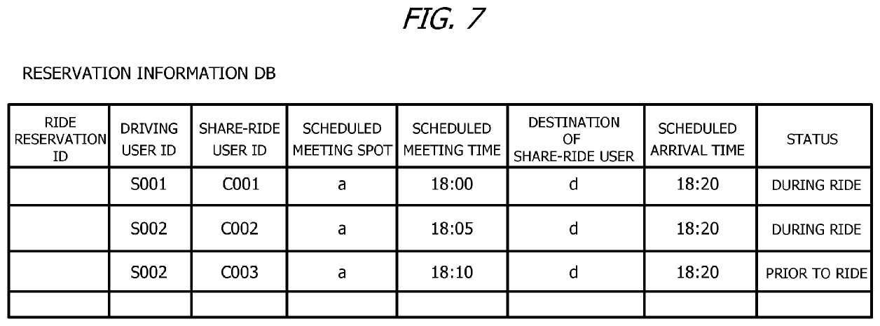

FIG. 7 is a diagram illustrating an example of a data structure of the reservation information DB 17. The reservation information DB 17 is a database that holds information on the ride reservation.

The reservation information DB 17 illustrated in FIG. 7 has fields of a ride reservation ID, a driving user ID, a share-ride user ID, the scheduled meeting spot, the scheduled meeting time, the destination of the share-ride user, the scheduled arrival time, and a status. In the field of the ride reservation ID, the identification information of the ride reservation is input. The identification information of the ride reservation is given by the reservation processing unit 11, for example, when the ride reservation request is received from the user terminal 200B. In the field of the driving user ID, the identification information of the driving user is input. In the field of the share-ride user ID, the identification information of the share-ride user is input.

In the field of the scheduled meeting spot, the information of the scheduled meeting spot determined by the matching processing unit 12 is input. For example, one of the latitude and longitude, the address and the landmark name may be input as the information of the scheduled meeting spot into the field of the scheduled meeting spot. In the field of the scheduled meeting time, the scheduled meeting time determined by the matching processing unit 12 is input.

The information stored in the fields of the share-ride user destination and the scheduled arrival time is input, for example, based on the schedule information of the share-ride user.

In the field of the status, the information indicating the status of the ride reservation is input. Examples of the status of the ride reservation include “prior to ride”, “during ride” and “completion”. An initial value of the field of the status is “prior to ride”. When the ride completion notification is received from the driving user terminal 200A and/or the share-ride user terminal 200B of the ride reservation, the reservation processing unit 11 of the center server 100 changes the corresponding status field of the ride reservation from “prior to ride” to “during ride”. When the arrival notification is received from the driving user terminal 200A and/or the share-ride user terminal 200B of the ride reservation, the reservation processing unit 11 of the center server 100 changes the corresponding status field of the ride reservation from “during ride” to “completion”.

Note that, for example, a flag, a code or the like is stored as the information indicating the status in the field of the status. The ride completion notification and the arrival notification from the driving user terminal 200A and/or the share-ride user terminal 200B of the ride reservation include the identification information of the ride reservation to specify the ride reservation.

The information stored in the reservation information DB 17 is registered, updated and deleted by the reservation processing unit 11. For example, when the ride reservation is determined, a new entry is registered in the reservation information DB 17 by the reservation processing unit 11. Note that the information stored in the reservation information DB 17 is not limited to the examples illustrated in FIG. 7, and the field can be suitably added, changed and deleted.

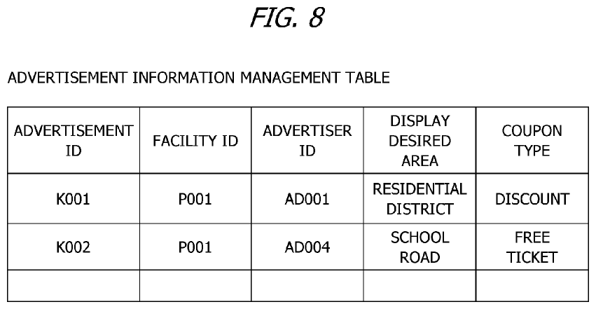

FIG. 8 is an example of an advertisement information management table stored in the advertisement information DB 18A. The advertisement information and the advertisement information management table are stored in the advertisement information DB 18A. Pieces of the identification information are given to pieces of the advertisement information, respectively. Examples of the advertisement information may include a still image, a moving image, and an audio video. The advertisement information management table is a table that stores information on the advertisement information.

The advertisement information management table includes fields of an advertisement ID, a facility ID, an advertiser ID, display desired area conditions and a coupon type. In the field of the advertisement ID, the identification information of the advertisement information is input. In the field of the facility ID, the identification information of the facility that is the target of the advertisement information is input. In the field of the advertiser ID, identification information of the advertiser is input.

In the field of the display desired area conditions, the conditions of the display desired area designated by the advertiser are input. Hereinafter, the conditions of the display desired area designated by the advertiser will be referred to as the display desired area conditions.

The display desired area conditions are designated, for example, by the features of the area, a city unit or a block number (a street number), a landmark, or the like. Examples of the features of the area include types, such as the residential district, the shopping district, a business district, and an industrial area. For example, a code indicating the type of feature of the area and a range thereof may be defined in the map information DB 18B. Furthermore, when the display desired area conditions are designated by the city unit, block number or the like, for example, an area where a purchaser class of goods for sale of the target facility of the advertisement information or a purchaser class of target goods of the advertisement information resides as much as a predetermined number or rate or more may be designated by an advertiser's research.

In the field of the coupon type, information indicating a type of coupon given as the incentive to the vehicle 50 that displays the advertisement information in the display device 51 is input. Examples of the type of coupon include a discount coupon that discounts a predetermined rate or amount, and a free ticket with which a predetermined service can be enjoyed for free. The information indicating the type of coupon is indicated, for example, by a flag, a code or the like. However, for convenience, FIG. 8 illustrates, for example, words of “discount” indicating the discount coupon and “free ticket” indicating the free ticket in the field of the coupon type. Note that the information included in the advertisement information management table is not limited to the information illustrated in FIG. 8.

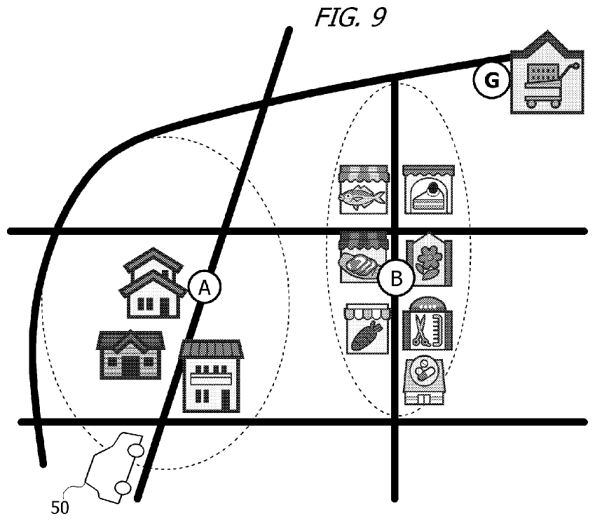

FIG. 9 is an explanatory view of route generation of the center server 100. The route generating unit 19 of the center server 100 generates the route in response to the request from the reservation processing unit 11. For example, on receiving the travel start notification from the in-vehicle device 300, the reservation processing unit 11 specifies the advertisement information corresponding to the facility that is present in the destination of the vehicle 50 on which the in-vehicle device 300 is mounted, based on the map information DB 18B and the advertisement information DB 18A. Next, the reservation processing unit 11, for example, reads the display desired area conditions of the specified advertisement information from the advertisement information management table of the advertisement information DB 18A, and outputs the display desired area conditions, the positional information of the vehicle 50 received together with the travel start notification and positional information of the destination to the route generating unit 19. The route generating unit 19 generates a route that passes a road within the area satisfying the input display desired area conditions, with reference to the map information DB 18B, for example, when generating the route from the current position of the vehicle 50 to the destination.

For example, FIG. 9 illustrates a road A within an area classified as the residential district, and a road B within an area classified as the shopping district. As the route from the position of the vehicle 50 to a destination G in FIG. 9, a route that passes the road A and a route that passes the road B are considered. For example, when the display desired area condition of the advertisement information based on the facility that is present in the destination G is “residential district”, the route generating unit 19 generates the route that passes the road A. For example, when the display desired area condition of the advertisement information based on the facility that is present in the destination G is “shopping district”, the route generating unit 19 generate the route that passes the road B. Note that it is defined that the area where the road A is present is “residential district” and that the area where the road B is present is “shopping district”, for example, in the map information DB 18B.

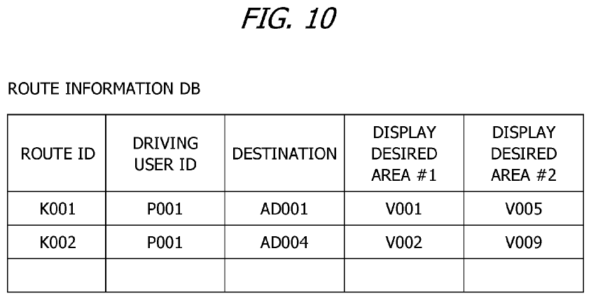

FIG. 10 is a diagram illustrating an example of a data structure of the route information DB 18C. The route information DB 18C is a database generated by the route generating unit 19 and storing the route information notified to the vehicle 50. The data structure of the route information DB 18C is a data structure having fields of a route ID, the driving user ID, the destination and the display desired area.

In the field of the route ID, identification information to identify the route is stored. In the field of the driving user ID, the identification information of the driving user associated with the in-vehicle device 300 to which the route information is transmitted in the user information DB 14 is stored. In the field of the destination, for example, the positional information of the destination is stored. Examples of the positional information stored in the destination field may include the latitude and longitude, the address, and the landmark.

In the field of the display desired area, positional information of the passing point within the display desired area which is included in the route is stored. The passing point within the display desired area is determined, for example, when the route is generated by the route generating unit 19. Examples of the positional information stored in the field of the display desired area may include the latitude and longitude, and the address. Furthermore, identification information that identifies the road set uniquely by the advertisement-for-vehicle distribution system 1 or identification information that identifies a spot may be stored in the field of the display desired area. There may be a plurality of display desired area fields, when the route includes a plurality of display areas.

For example, the route information DB 18C is for use in confirming that the vehicle 50 that displays the advertisement information travels along the route notified from the center server 100. The reservation processing unit 11 of the center server 100 acquires the positional information of the vehicle 50 from the in-vehicle device 300 in a predetermined period. For example, the reservation processing unit 11 records the actual travel route of the vehicle 50, and compares the actual travel route with the route information of the vehicle 50 stored in the route information DB 18C, when the vehicle 50 arrives at the destination. When the vehicle 50 travels via the display desired area, the reservation processing unit 11 may issue the coupon as the incentive regardless of a riding capacity of the vehicle 50. Note that the data structure of the route information DB 18C is not limited to the data structure illustrated in FIG. 10.

<Flow of Processing>

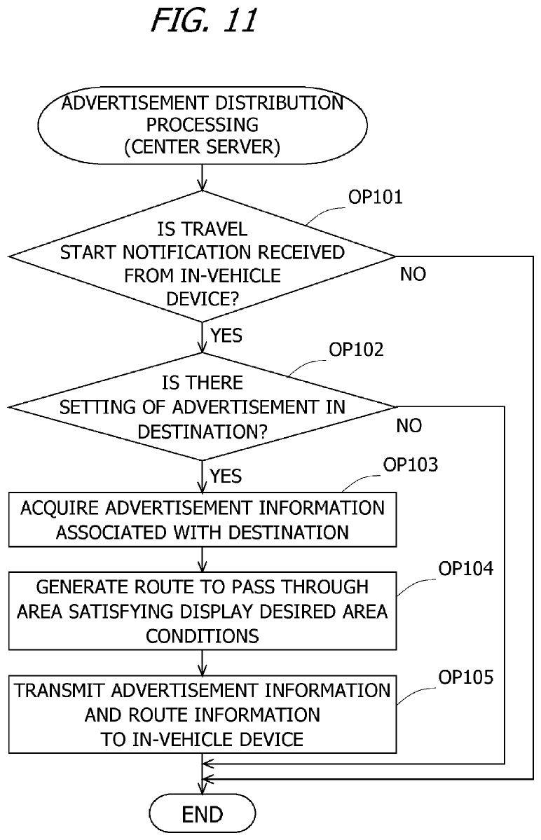

FIG. 11 is an example of a flowchart of advertisement distribution processing of the center server 100 according to the first embodiment. The advertisement distribution processing is processing to distribute, to the vehicle 50, the advertisement information associated with the destination of the vehicle 50. The processing illustrated in FIG. 11 is executed, for example, in a predetermined period. An execution subject of the processing illustrated in FIG. 11 is the processor 101 of the center server 100, but the reservation processing unit 11 that is the functional component will be described as the subject for convenience. This also applies to the subsequent flowchart of the processing of the center server 100.

In OP101, the reservation processing unit 11 judges whether or not the travel start notification is received from the in-vehicle device 300 through the transmitting and receiving unit 13. When the travel start notification is received from the in-vehicle device 300 (OP101: YES), the processing advances to OP102. When the travel start notification is not received from the in-vehicle device 300 (OP101: NO), the processing illustrated in FIG. 11 ends. The destination information of the vehicle 50 on which the in-vehicle device 300 of the source is mounted is also received together with the travel start notification.

In the OP102, the reservation processing unit 11 judges whether or not there is setting of the advertisement information associated with the destination of the vehicle 50. In this judgment, for example, the facility that is present in the destination is specified with reference to the map information DB 18B, and the advertisement information associated with the facility is specified with reference to the advertisement information DB 18A. When there is the setting of the advertisement information associated with the destination of the vehicle 50 (OP102: YES), the processing advances to OP103. When there is not any setting of the advertisement information associated with the destination of the vehicle 50 (OP102: NO), the processing illustrated in FIG. 11 ends.

In the OP103, the reservation processing unit 11 acquires the advertisement information associated with the destination of the vehicle 50 from the advertisement information DB 18A. At this time, the reservation processing unit 11 also reads information on the advertisement information associated with the destination of the vehicle 50 from the advertisement information management table in the advertisement information DB 18A.

In OP104, the reservation processing unit 11 outputs, to the route generating unit 19, the current position of the vehicle 50, the destination of the vehicle 50, and the display desired area conditions of the advertisement information set in the advertisement information management table, to request the generation of the route. The route generating unit 19 generates the route that passes through the display desired area satisfying the display desired area conditions to the destination, to output the route to the reservation processing unit 11.

In OP105, the reservation processing unit 11 transmits the advertisement information acquired in the OP103, the display instruction of the advertisement information, and the route information generated in the OP104 to the in-vehicle device 300 of the source of the travel start notification. Afterward, the processing illustrated in FIG. 11 ends. Note that the advertisement distribution processing of the center server 100 illustrated in FIG. 11 is an example, and the present embodiment is not limited to this example.

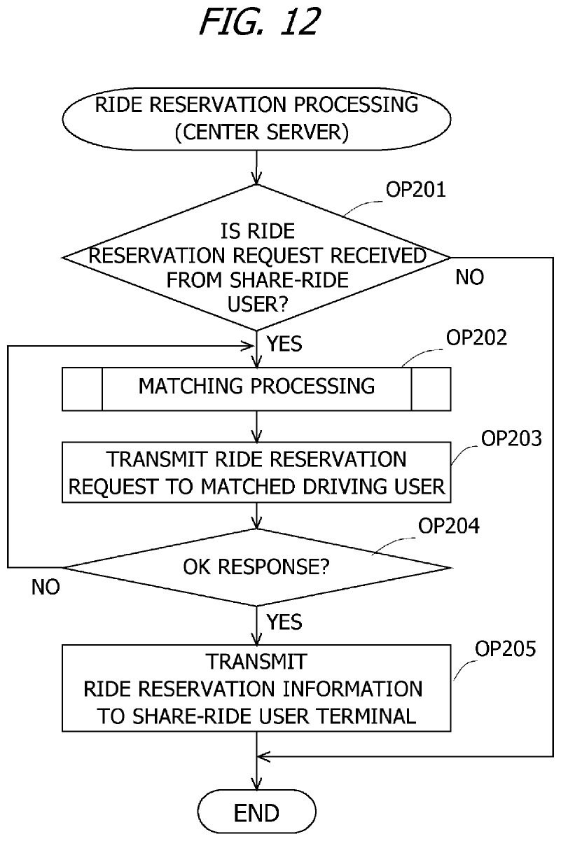

FIG. 12 is an example of a flowchart of ride reservation processing of the center server 100 according to the first embodiment. The processing illustrated in FIG. 12 is executed, for example, in a predetermined period. The ride reservation processing is processing to match the share-ride user with the driving user and establish the ride reservation.

In OP201, the reservation processing unit 11 judges whether or not the ride reservation request is received from the share-ride user terminal 200B through the transmitting and receiving unit 13. When the ride reservation request is received from the share-ride user terminal 200B (OP201: YES), the processing advances to OP202. When the ride reservation request is not received (OP201: NO), the processing illustrated in FIG. 12 ends.

In the OP202, the reservation processing unit 11 requests the matching processing unit 12 to match the share-ride user of the share-ride user terminal 200B, so that the driving user of the matching target, the scheduled meeting spot, the scheduled meeting time and the like are determined by the matching processing unit 12.

In OP203, the reservation processing unit 11 transmits the ride reservation request to the driving user terminal 200A of the matched driving user through the transmitting and receiving unit 13. In OP204, the reservation processing unit 11 judges whether or not the OK response to the ride reservation request is received from the driving user terminal 200A. When the OK response to the ride reservation request is received from the driving user terminal 200A (OP204: YES), the processing advances to OP205. For example, when, even after elapse of a predetermined time, the OK response to the ride reservation request is not received from the driving user terminal 200A, or an NG response is received therefrom (OP204: NO), the processing advances to the OP202, thereby performing the matching processing again. Even when the matching processing is performed a predetermined number of times or more, the OK response is not received from the driving user terminal 200A of the matching target. In this case, the processing of FIG. 12 may end.

In the OP205, the reservation processing unit 11 transmits the notification of the ride reservation establishment to the share-ride user terminal 200B of the source of the ride reservation request through the transmitting and receiving unit 13. Furthermore, the reservation processing unit 11 stores the ride reservation information in the reservation information DB 17. Afterward, the processing illustrated in FIG. 12 ends. Note that the ride reservation processing in the case where the ride reservation request is received is not limited to the processing illustrated in FIG. 12.

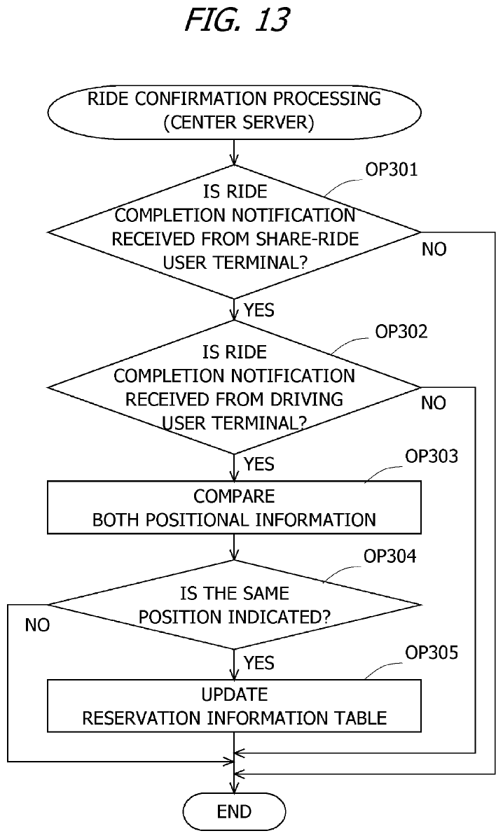

FIG. 13 is an example of a flowchart of ride confirmation processing of the center server 100 according to the first embodiment. The ride confirmation processing is processing to confirm that the share-ride user rides in the vehicle 50 of the ride reservation. The processing illustrated in FIG. 13 is executed, for example, in a predetermined period.

In OP301, the reservation processing unit 11 judges whether or not the ride completion notification is received from the share-ride user terminal 200B through the transmitting and receiving unit 13. When the ride completion notification is received from the share-ride user terminal 200B (OP301: YES), the processing advances to OP302. When the ride completion notification is not received from the share-ride user terminal 200B (OP301: NO), the processing illustrated in FIG. 13 ends.

In the OP302, the reservation processing unit 11 judges whether or not the ride completion notification is received from the driving user terminal 200A through the transmitting and receiving unit 13. When the ride completion notification is received from the driving user terminal 200A (OP302: YES), the processing advances to OP303. When the ride completion notification is not received from the driving user terminal 200A (OP302: NO), the processing illustrated in FIG. 13 ends. That is, in an example illustrated in FIG. 13, the receiving of the ride completion notification from both the share-ride user terminal 200B and the corresponding driving user terminal 200A in the ride reservation information is one of conditions of confirmation that the share-ride user rides in the vehicle 50 of the ride reservation. However, the present embodiment is not limited to this example.

In the OP303, the reservation processing unit 11 compares the positional information of the driving user terminal 200A with that of the corresponding share-ride user terminal 200B in the ride reservation information. In OP304, it is judged whether or not the positional information of the driving user terminal 200A and that of the corresponding share-ride user terminal 200B in the ride reservation information indicate the same position. Note that when a distance between both the terminals is less than a predetermined range, it can be considered that the same position is indicated.

When the positional information of the driving user terminal 200A and that of the corresponding share-ride user terminal 200B in the ride reservation information indicate the same position (OP304: YES), the processing advances to OP305. When the positional information of the driving user terminal 200A and that of the corresponding share-ride user terminal 200B in the ride reservation information do not indicate the same position (OP304: NO), the processing illustrated in FIG. 13 ends.

In the OP305, the reservation processing unit 11 updates the status field of the entry of a reservation information table of the reservation information DB 17 up to information indicating “during ride”. Afterward, the processing illustrated in FIG. 13 ends. Note that the ride confirmation processing of the center server 100 illustrated in FIG. 13 is an example, and the present embodiment is not limited to this example. For example, an execution order of the processing of the OP301 and the OP302 may be reversed.

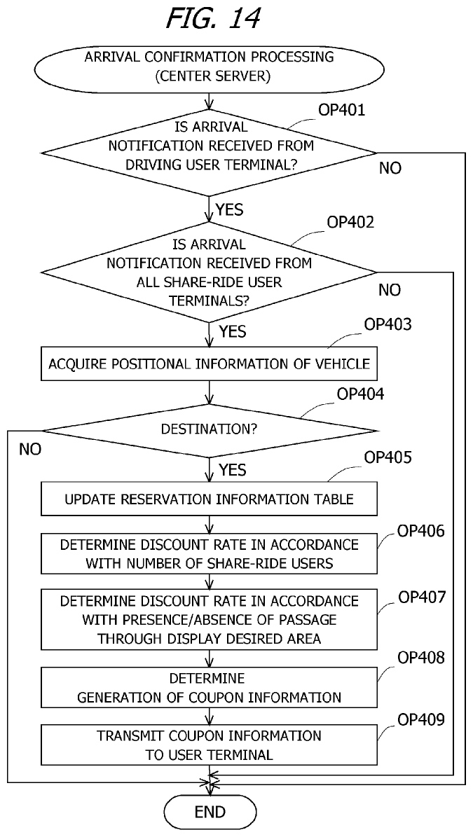

FIG. 14 is an example of a flowchart of arrival confirmation processing of the center server 100 according to the first embodiment. The arrival confirmation processing is processing to confirm the arrival at the destination of the ride reservation. The processing illustrated in FIG. 14 is executed, for example, in a predetermined period.

In OP401, the reservation processing unit 11 judges whether or not the arrival notification is received from the driving user terminal 200A through the transmitting and receiving unit 13. When the arrival notification is received from the driving user terminal 200A (OP401: YES), the processing advances to OP402. When the arrival notification is not received from the driving user terminal 200A (OP401: NO), the processing illustrated in FIG. 14 ends.

In the OP402, the reservation processing unit 11 judges, in the ride reservation, whether or not the arrival notification is received from all the share-ride user terminals 200B associated with the driving user terminal 200A of the source of the arrival notification in the OP401. When the arrival notification is received from all the share-ride user terminals 200B (OP402: YES), the processing advances to OP403. When the arrival notification is not received from all the share-ride user terminals 200B (OP402: NO), the processing illustrated in FIG. 14 ends. Note that in the ride reservation, the share-ride user terminal 200B associated with the driving user terminal 200A of the source of the arrival notification in the OP401 can be specified from the information stored in the reservation information DB 17.

In the OP403, the reservation processing unit 11 acquires the positional information of the vehicle 50 associated with the driving user terminal 200A. For example, the reservation processing unit 11 may acquire the latest piece of the positional information received from the in-vehicle device 300 mounted in the vehicle 50 in the predetermined period, or may inquire the in-vehicle device 300 to acquire the information.

In OP404, the reservation processing unit 11 judges whether or not the positional information of the vehicle 50 coincides with the destination of the driving user associated with the vehicle 50. When the positional information of the vehicle 50 coincides with the destination of the driving user associated with the vehicle 50 (OP404: YES), the processing advances to OP405. When the positional information of the vehicle 50 does not coincide with the destination of the driving user associated with the vehicle 50 (OP404: NO), the processing illustrated in FIG. 14 ends. Note that when a distance between the positional information of the vehicle 50 and the destination of the driving user associated with the vehicle 50 is in a predetermined range, it is considered that both destinations coincide with each other.

In the OP405, the reservation processing unit 11 updates the status of the corresponding reservation information of the reservation information DB 17 from “during ride” up to information indicating “completion”.

In OP406, the reservation processing unit 11 determines the discount rate or the discount amount in accordance with the number of the share-ride users who are in the vehicle 50 on the arrival at the destination. Note that when the coupon type set to the advertisement information displayed in the vehicle 50 is other than “discount”, the processing of the OP406 is omitted. The number of the share-ride users who are in the vehicle 50 on the arrival at the destination is, for example, the number of updates of the status of the reservation information up to the information indicating “completion” in the OP405. Furthermore, setting information of the discount rate or the discount amount corresponding to the number of the share-ride users who are in the vehicle 50 on the arrival at the destination is, for example, determined in advance by the advertiser, and stored in the advertisement information DB 18A.

In OP407, the reservation processing unit 11 compares a travel route of the vehicle 50 acquired by monitoring the positional information of the vehicle 50 with the route information stored in the route information DB 18C and transmitted to the in-vehicle device 300. The reservation processing unit 11 judges whether or not the vehicle 50 passes through the display desired area included in the route information stored in the route information DB 18C. The reservation processing unit 11 adds the predetermined value to the discount rate or the discount amount of the coupon, when the vehicle 50 passes through the display desired area included in the route information stored in the route information DB 18C. Note that when the coupon type set to the advertisement information displayed in the vehicle 50 is other than “discount”, and when the vehicle 50 passes through the display desired area included in the route information stored in the route information DB 18C in the OP407, the coupon may be issued.

In OP408, the reservation processing unit 11 generates the coupon, for example, in accordance with the advertisement information management table. In OP409, the reservation processing unit 11 transmits the generated coupon to the driving user terminal 200A and all the share-ride user terminals 200B associated with the driving user terminal 200A in the ride reservation, through the transmitting and receiving unit 13. Afterward, the processing illustrated in FIG. 14 ends. Note that the arrival confirmation processing of the center server 100 is not limited to the processing illustrated in FIG. 14.

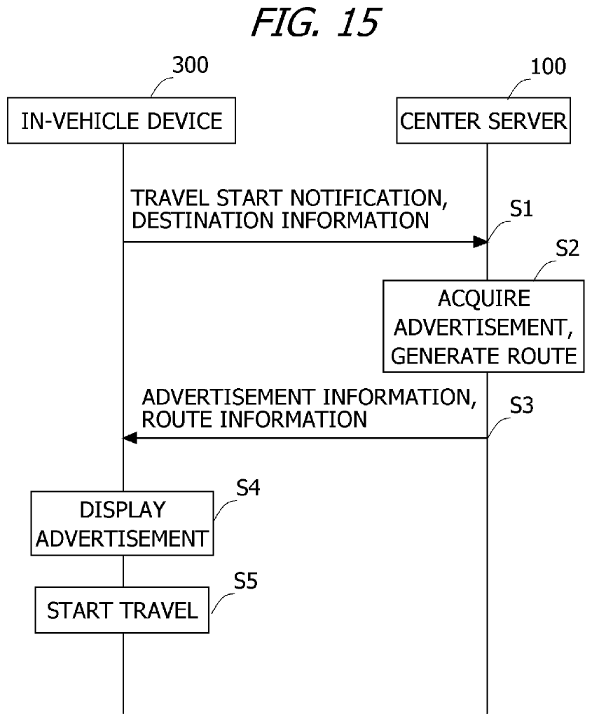

FIG. 15 is a diagram illustrating an example of a sequence of the processing of the advertisement-for-vehicle distribution system 1 when the vehicle 50 starts traveling. In S1, the in-vehicle device 300 mounted in the vehicle 50 detects the travel start of the vehicle 50, acquires the destination of the vehicle 50, and transmits the travel start notification and the destination information to the center server 100. The center server 100 receives the travel start notification and the destination information from the in-vehicle device 300 (FIG. 11, OP101).

In S2, the center server 100 acquires the advertisement information corresponding to the destination (FIG. 11, OP103), and generates the route that passes through the area satisfying the display desired area conditions set to the acquired advertisement information (FIG. 11, OP104). In S3, the center server 100 transmits the advertisement information, the display instruction of the advertisement information and the route information to the in-vehicle device 300 (FIG. 11, OP105).

In S4, the in-vehicle device 300 displays the advertisement information received from the center server 100 in the display device 51. In S5, the in-vehicle device 300 sets the route information received from the center server 100 to the car navigation device 52. Afterward, the in-vehicle device 300 operates.

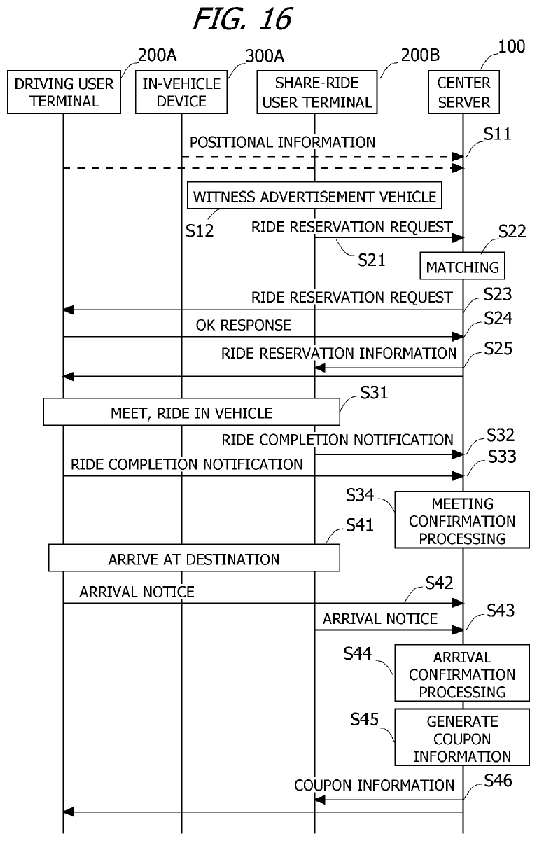

FIG. 16 is a diagram illustrating an example of a sequence of processing in the advertisement-for-vehicle distribution system 1, when the share-ride user rides in the vehicle 50. It is considered that the vehicle 50 is displaying the advertisement information of facility A that is present in the destination in the display device 51 directed toward the outside of the vehicle. It is considered that an in-vehicle device 300A is mounted in the vehicle 50.

In S11, the in-vehicle device 300A and the driving user terminal 200A of the driving user of the vehicle 50 transmit the positional information to the center server 100 in a predetermined period.

In S12, the share-ride user witnesses the vehicle 50 and the advertisement information of the facility A which is displayed in the display device 51 of the vehicle 50. Consequently, it is assumed that the share-ride user is the target of the advertisement information and determines to go to the facility A of the destination of the vehicle 50.

In S21, the share-ride user operates the share-ride user terminal 200B, to transmit the ride reservation request for the facility A of the destination to the center server 100. The ride reservation request includes the schedule information including the destination.

In S22, the center server 100 receives the ride reservation request from the share-ride user terminal 200B (FIG. 12, OP201: YES), to perform the matching processing (FIG. 12, OP202). It is considered that as a result of the matching, the vehicle 50 in which the in-vehicle device 300A is mounted is selected as the vehicle in which the share-ride user rides.

In S23, the center server 100 transmits the ride reservation request of the share-ride user to the driving user terminal 200A associated with the vehicle 50 (FIG. 12, OP203). In S24, the driving user terminal 200A receives the ride reservation request from the center server 100, and transmits the OK response to the center server 100, when the OK response is input by the operation of the driving user.

In S25, the center server 100 receives the OK response from the driving user terminal 200A (FIG. 12, OP204: YES), determines the ride reservation, and transmits the ride reservation information to the share-ride user terminal 200B and the driving user terminal 200A (FIG. 12, OP205).

In S31, it is the scheduled meeting time of the ride reservation. At the scheduled meeting spot, the vehicle 50 meets the share-ride user, and the share-ride user rides in the vehicle 50. In S32, the share-ride user operates the share-ride user terminal 200B, so that the ride completion notification is transmitted from the share-ride user terminal 200B to the center server 100. The center server 100 receives the ride completion notification from the share-ride user terminal 200B (FIG. 13, OP301: YES). In S33, the driving user operates the driving user terminal 200A, so that the ride completion notification is transmitted from the driving user terminal 200A to the center server 100. The center server 100 receives the ride completion notification from the driving user terminal 200A (FIG. 13, OP302: YES).

In S34, as the ride confirmation processing, the center server 100 compares the positional information of the driving user terminal 200A with that of the share-ride user terminal 200B, and confirms that both information coincide with each other (FIG. 13, OP303, OP304).

In S41, the vehicle 50 arrives at the destination. In S42, the driving user operates the driving user terminal 200A, so that the arrival notification is transmitted from the driving user terminal 200A to the center server 100. The center server 100 receives the arrival notification from the driving user terminal 200A (FIG. 14, OP401: YES). In S43, the share-ride user operates the share-ride user terminal 200B, so that the arrival notification is transmitted from the share-ride user terminal 200B to the center server 100. The center server 100 receives the arrival notification from the share-ride user terminal 200B (FIG. 14, OP402: YES). Note that in the example illustrated in FIG. 16, it is considered that one share-ride user is in the vehicle 50.

In S44, as the arrival confirmation processing, the center server 100 acquires the positional information of the vehicle 50 (the in-vehicle device 300) (FIG. 14, OP403), and confirms, based on the positional information, that the vehicle 50 is located at the destination (FIG. 14, OP404).

In S45, the center server 100 generates the coupon information (FIG. 14, OP406 to OP408). In the example illustrated in FIG. 16, it is assumed that the type of coupon set to the advertisement information displayed in the display device 51 of the vehicle 50 is “discount”. In the example illustrated in FIG. 16, it is assumed that one share-ride user is in the vehicle 50, and hence, the center server 100 determines the discount rate in accordance with the number of the share-ride users which is one. For example, the discount rate is 5% in case of one share-ride user, 8% in case of two share-ride users, and 10% in case of three share-ride users. However, the present embodiment is not limited to this example. Furthermore, when the vehicle 50 travels in accordance with the route information notified from the center server 100 and passes through the passing point included in the route information, a value is further added to the discount rate or the discount amount.

In S46, the center server 100 transmits the generated coupon information to the driving user terminal 200A and the share-ride user terminal 200B (FIG. 14, OP409). Afterward, for example, the center server 100 may transmit an end notification of advertisement display to the in-vehicle device 300 to end the display of the advertisement information of the vehicle 50, or the in-vehicle device 300 may detect the arrival at the destination from the positional information to end the display of the advertisement information.

<Operation and Effects of First Embodiment>

In the first embodiment, the advertisement information associated with the destination is displayed in the display device 51 directed toward the outside of the vehicle 50 provided for the ridesharing service. Consequently, for example, it is possible to appeal to the pedestrians for the vehicle heading for the destination, and it is possible to motivate the pedestrians for visits to the destination. A customer attraction effect to the facility of the target by the advertisement information can improve. Furthermore, the user who goes to the destination can be urged to ride in the vehicle 50, that is, to use the ridesharing service.

Furthermore, in the first embodiment, the center server 100 generates the route to pass through the area satisfying the display desired area conditions designated by the advertiser of the advertisement information displayed in the display device 51 directed toward the outside of the vehicle 50. The advertiser has, for example, a high possibility of designating the area where more users targeted by the advertisement information are present, based on the display desired area conditions. When the vehicle 50 travels along the route, the vehicle passes through the area where more users targeted by the advertisement information are present. Therefore, it is possible to appeal to more targeted users for the advertisement information, and an advertising effect of the advertisement information can improve.

Additionally, in the first embodiment, when distribution of the discount coupon as the coupon type is set to the advertisement information, the center server 100 determines the discount rate or the discount amount in accordance with the number of the share-ride users who are in the vehicle for the destination. Consequently, the driving user and the share-ride user can be motivated to use the ridesharing service.

Further in the first embodiment, the center server 100 determines the discount rate or the discount amount, or determines the distribution of free coupons, when the vehicle 50 passes through the display desired area included in the route generated by the center server 100. Consequently, the driving user can be motivated to drive the vehicle 50 to travel along the route generated by the center server 100 and including the area where the presence of the user corresponding to the target of the advertisement information is expected.

### OTHER EMBODIMENTS

The embodiment described above is an example, and the present disclosure may be changed and carried out as appropriate without departing from the gist of the present disclosure.

In the first embodiment, the processing performed by the driving user terminal 200A or the in-vehicle device 300 may be performed singly by the in-vehicle device 300 or singly by the driving user terminal 200A.

Furthermore, in the first embodiment, as the ride confirmation processing, the center server 100 compares the positional information of the driving user terminal 200A with that of the corresponding share-ride user terminal 200B in the ride reservation, but this processing may be omitted in accordance with the embodiment. Additionally, in the first embodiment, as the arrival confirmation processing, the center server 100 confirms the positional information of the vehicle 50, but this processing may be omitted in accordance with the embodiment. Conversely, as the arrival confirmation processing, the center server 100 may confirm the positional information of each of the driving user terminal 200A and the share-ride user terminal 200B in the ride reservation, in addition to the confirmation of the positional information of the vehicle 50.

Additionally, points may be assigned to each display desired area in advance, and the discount amount or the discount rate may be determined based on the points given to the passed display desired area, when the vehicle 50 passes through the display desired area included in the route generated by the center server 100.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising:
a processor configured to execute:
acquiring a destination of a crew of a first vehicle that is a vehicle including a display device installed toward an outside of the vehicle and that is able to carry a first user who wants to move by a vehicle,
acquiring advertisement information associated with the destination,
generating a route of the first vehicle to the destination such that the first vehicle passes through an area where presence of a user corresponding to a target of the advertisement information is expected, and
transmitting, to the first vehicle, the advertisement information, a display instruction of the advertisement information to the display device, and route information of the generated route.

2. The information processing apparatus according to claim 1, wherein when the first vehicle arrives at the destination, the processor is configured to execute:
determining a discount rate or a discount amount of a coupon usable in a facility that is present in the destination in accordance with the number of the first users who ride together in the first vehicle, and
transmitting the coupon to a user terminal owned by the crew of the first vehicle.

3. The information processing apparatus according to claim 1, wherein when the first vehicle arrives at the destination, the processor is configured to execute:
determining a discount rate or a discount amount of a coupon usable in a facility that is present in the destination in accordance with presence/absence of passage through the area included in the generated route, and
transmitting the coupon to the user terminal owned by the crew of the first vehicle.

4. An information processing system comprising:
one or more processors configured to execute:
acquiring a destination of a crew of a first vehicle that is a vehicle including a display device installed toward an outside of the vehicle and that is able to carry a first user who wants to move by a vehicle,
acquiring advertisement information associated with the destination,
generating a route of the first vehicle to the destination such that the first vehicle passes through an area where presence of a user corresponding to a target of the advertisement information is expected, and
transmitting, to the first vehicle, the advertisement information, a display instruction of the advertisement information to the display device, and route information of the generated route.

5. An advertisement distribution method comprising:
acquiring a destination of a crew of a first vehicle that is a vehicle including a display device installed toward an outside of the vehicle and that is able to carry a first user who wants to move by a vehicle,
acquiring advertisement information associated with the destination,
generating a route of the first vehicle to the destination such that the first vehicle passes through an area where presence of a user corresponding to a target of the advertisement information is expected, and
transmitting, to the first vehicle, the advertisement information, a display instruction of the advertisement information to the display device, and route information of the generated route.
